(19) United States
(12) Patent Application Publication
(10) Pub. No.: US 2012/0291247 A1
(43) Pub. Date: Nov. 22, 2012

(54) ANTENNA ASSEMBLY FIXTURE

(75) Inventor: XIN-YAN WANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/325,720

(22) Filed: Dec. 14, 2011

(30) Foreign Application Priority Data
May 20, 2011 (CN) 201110131292.9

(51) Int. Cl. B23Q 3/18

(52) U.S. Cl. 29/281.1

(57) ABSTRACT

An antenna assembly fixture used to assemble a securing frame to an antenna includes a base body, a first mounting structure, a sliding structure, and a second mounting structure. The first mounting structure located on the base body defines a first mounting slot for holding the antenna. The sliding structure includes two positioning plates located on the base body, guiding post at the positioning plates, and a sliding portion located between the positioning plates. The second mounting structure located on the sliding portion defines a second mounting slot. The second mounting slot is aligned with the first mounting slot and holds the securing frame, the sliding portion moves along the guiding post and enables the securing frame to move towards the antenna, and the securing frame and the antenna are assembled together.

### BACKGROUND

1. Technical Field

The disclosure generally relates to an assembly fixture for assembling antennas.

2. Description of the Related Art

Circular antennas for mobile phones can be easily deformed during assembly; accordingly, a fixing frame is used to secure and support the circular antenna in the mobile phone by adhesion. However, the above assembly is manually performed and thus the process can be slow and time consuming and further may result in unwanted gaps between the antenna and the frame.

Therefore, there is room for improvement within the art.

### BRIEF DESCRIPTION OF THE DRAWINGS

Many aspects of an antenna assembly fixture can be better understood with reference to the following drawings. The components in the drawings are not necessarily drawn to scale, the emphasis instead being placed upon clearly illustrating the principles of the antenna assembly fixture. Moreover, in the drawings, like reference numerals designate corresponding parts throughout the several views. Wherever possible, the same reference numbers are used throughout the drawings to refer to the same or like elements of an embodiment.

FIG. 1 is a disassembled view of an antenna assembly fixture including a clamping structure, according to an embodiment of the disclosure.

FIG. 2 is a disassembled view of the antenna assembly fixture shown in FIG. 1, but viewed from another angle.

FIG. 3 is disassembled view of the clamping structure shown in FIG. 1.

FIG. 4 is schematic view of illustrating that the clamping structure fastens an antenna shown in FIG. 3 of the disclosure.

FIG. 5 is schematic view of the antenna assembly fixture used for assembling the antenna to a securing frame shown in FIG. 4.

FIG. 6 is similar to FIG. 5, but viewed from another angle.

FIG. 7 is an assembled view of the antenna assembly fixture of the disclosure.

### DETAILED DESCRIPTION

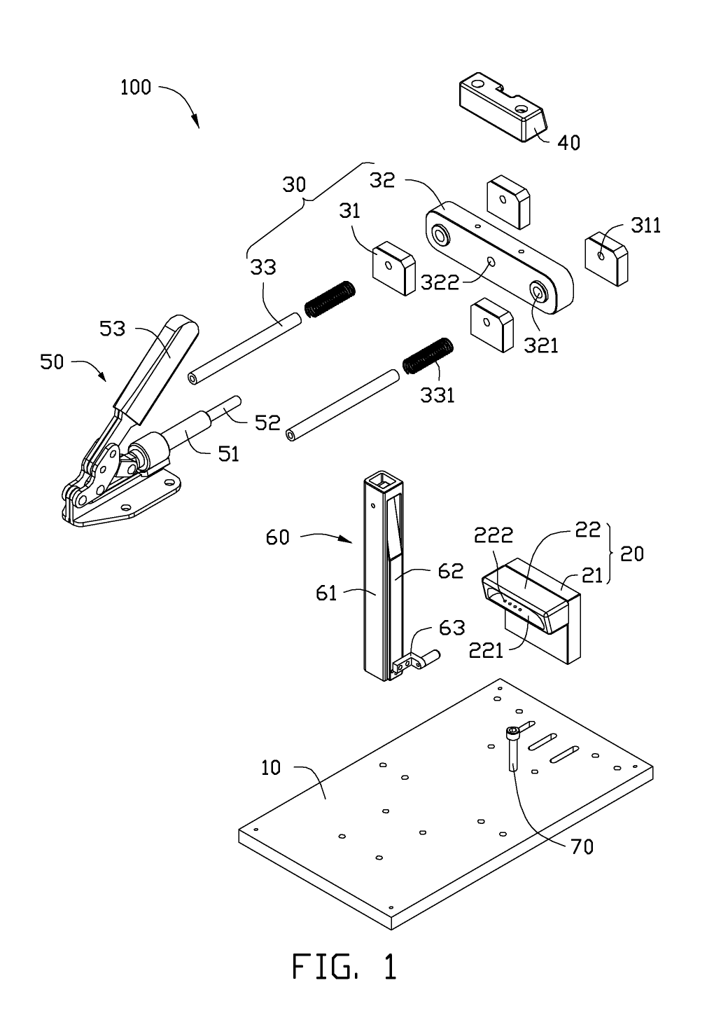

FIG. 1 is disassembled view of an antenna assembly fixture 100 including a clamping structure 60, according to an embodiment of the disclosure. In this embodiment, the antenna assembly fixture 100 is used to assemble an antenna 80 to a securing frame 90. The assembly fixture 100 further includes a base body 10, a first mounting structure 20, a sliding structure 30, a second mounting structure 40, and a driving structure 50.

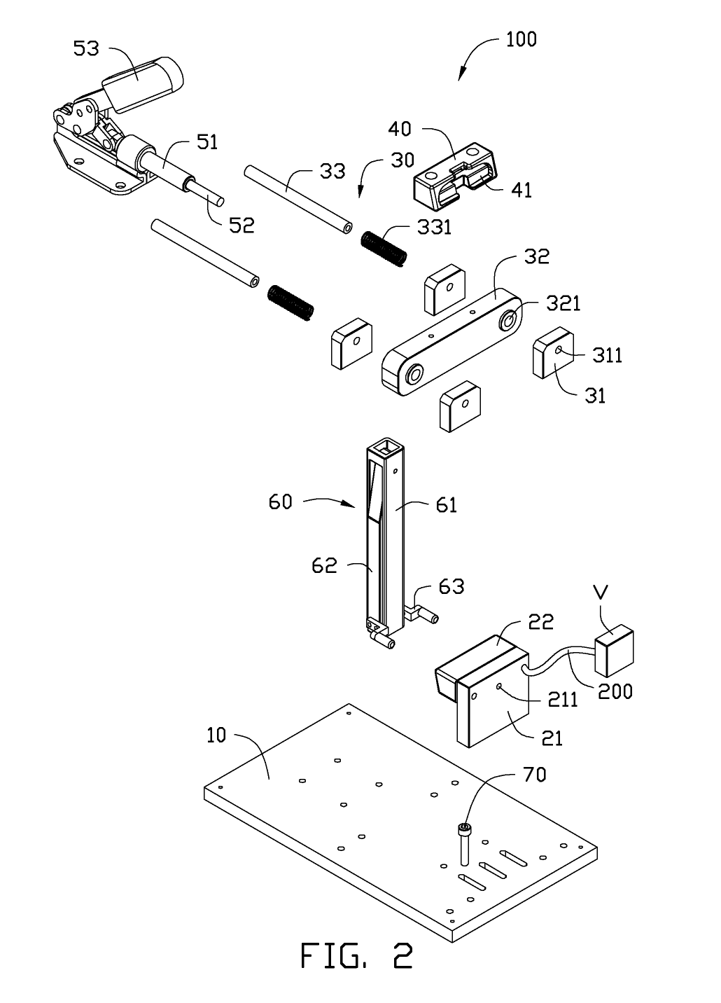

Referring to FIG. 2, the base body 10 is substantially a rectangular plate and provides a supporting surface for the first mounting structure 20, the sliding structure 30, the second mounting structure 40 and the driving structure 50.

The first mounting structure 20 includes a fixing plate 21 and a mounting portion 22. In this embodiment, the fixing plate 21 is substantially a rectangular plate and is detachably located onto the base body 10. The fixing plate 21 defines a plurality of through air holes 211. The mounting portion 22 is detachably assembled on one side of the fixing plate 21, and defines a mounting slot 221. The size and shape of the mounting slot 221 are substantially the same as those of the antenna 80 for accommodating the antenna 80.

The mounting portion 22 further defines a plurality of suction holes 222 in the first mounting slot 221, and the suction holes 222 communicate with the corresponding air holes 211. The air holes 211 communicate with a vacuum source V through air pipes 200. When the vacuum source V is activated, air is sucked out the air holes 211 and the suction holes 222 through the air pipes 200, to hold the antenna 80 with suction to prevent the antenna 80 from falling off the first mounting portion 22.

The sliding structure 30 includes four positioning plates 31, a sliding portion 32 and two guiding posts 33. The four positioning plates 31 are substantially rectangular. Two positioning plates 31 are located at one side of the first mounting structure 20, and the other two positioning plates 31 are located at the opposite side of the first mounting structure 20. Each positioning plate 31 defines a positioning hole 311.

In this embodiment, the sliding portion 32 is substantially rectangular plate and defines two sliding holes 321 at opposite ends of the sliding portion 32. Each sliding hole 321 is aligned with two positioning holes 311 of the two positioning plates 31. The two positioning holes 311 are located at the opposite sides of the sliding portion 32. The sliding portion 32 further defines a connection hole 322 between the sliding holes 321. Each guiding post 33 is substantially a cylinder and includes an elastic member 331.

The size and shape of the guiding post 33 is matched with the sliding hole 321. Each guiding post 33 can pass through the sliding hole 321 and be removable in the sliding hole 321. The opposite ends of the guiding post 33 are detachably fixed in the two positioning holes 311, and each elastic member 331 is elastically located between the positioning plate 31 and the sliding portion 32. Thus, the sliding portion 32 can move back-and-forth along the sliding posts 33, and the elastic members 331 are deformed.

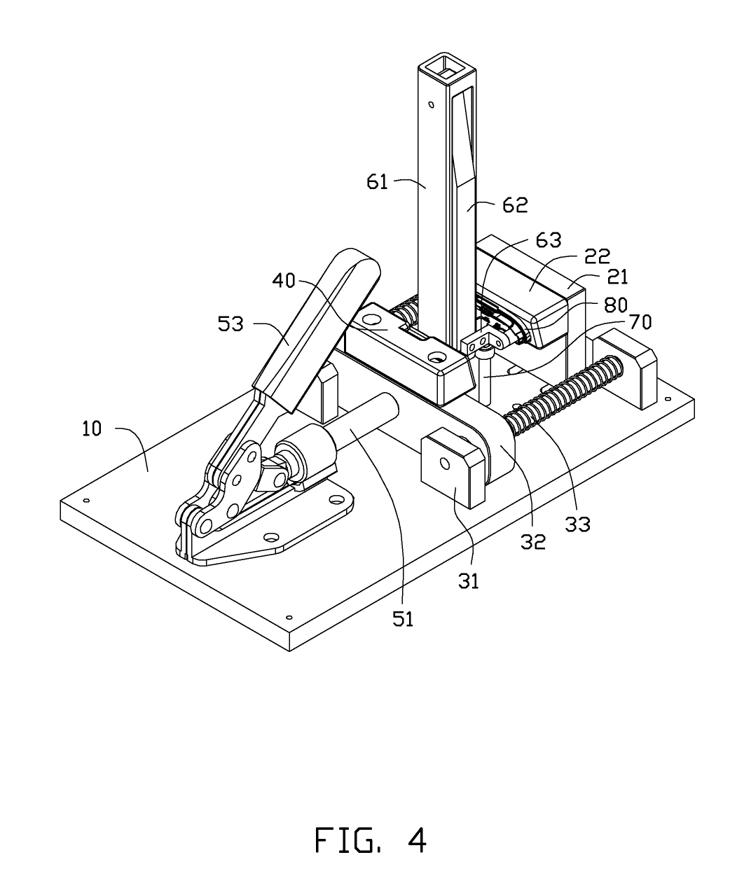

Also referring to FIG. 4, the second mounting structure 40 is substantially rectangular, and is assembled on the sliding portion 32 for example by threads, and faces the first mounting structure 20. Thus, the sliding portion 32 drives the second mounting structure 40 to move towards or away from the first mounting structure 20. The second mounting structure 40 defines a second mounting slot 41 facing the first mounting structure 20. In this embodiment, the size and shape of the second mounting slot 41 is substantially the same as those of the securing frame 90 to receive the securing frame 90.

The driving structure 50 can be a hand-operated valve and is detachably fixed on the base body 10. The driving structure 50 includes a drive cylinder 51, a connection post 52, and a drive handle 53. The drive cylinder 51 is a substantially hollow cylinder. One end of the connection post 52 is fixed in the connection hole 322 of the sliding portion 32, and the other end of the connection post 52 is removably received within the drive cylinder 51. The drive handle 53 is connected to the drive cylinder 51 to push and pull the drive cylinder 51. Thus, the connection post 52 moves back-and-forth in the drive cylinder 51 to further enable the sliding portion 32 to slide back-and-forth along the guiding posts 33.

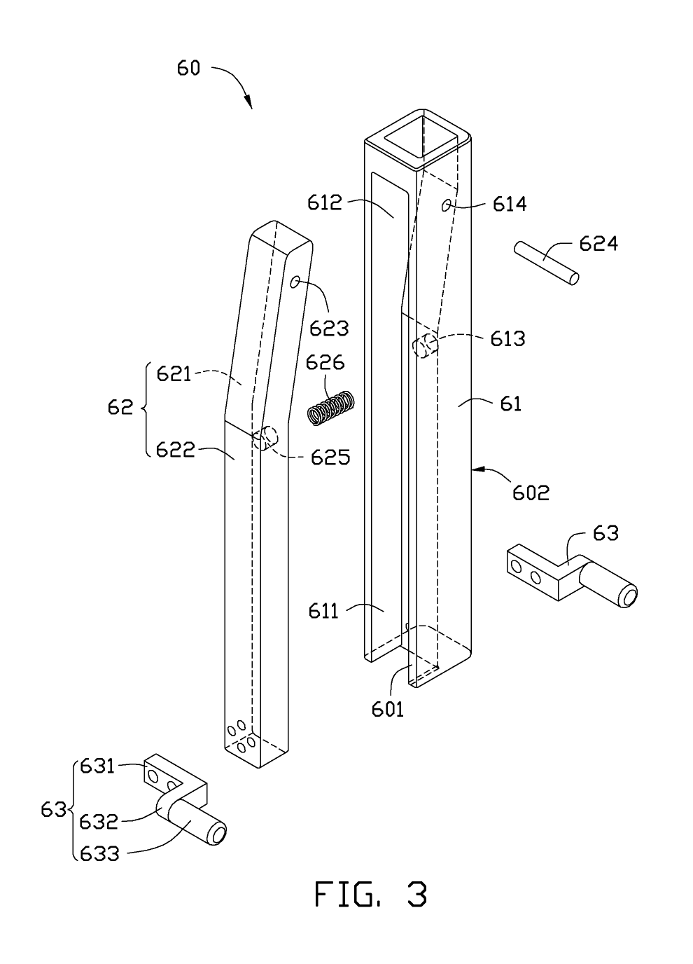

Referring to FIG. 3, the clamping structure 60 clamps and moves the antenna 80 into the first mounting slot 221. The clamping structure 60 includes a main body 61, a pressing portion 62 and two clamping portions 63. The main body 61 is a substantially rectangular strip, and includes a first surface 601 and a second surface 602 parallel to the first surface 601. The main body 61 defines a first receiving space 611, a second receiving space 612, and a groove 613. The first receiving space 611 is substantially a rectangular slot and is located at the first surface 601. The second receiving space 612 is a substantially wedge-shaped slot and is located at the first surface 601, and communicates with the first receiving space 611. The groove 613 is located at the bottom of the first receiving space 611 and is adjacent to the second receiving space 612. The second receiving space 612 defines two fixing holes 614 at the opposite sidewalls.

The pressing portion 62 includes a rotating section 621 and a pressing section 622 connecting to the rotating section 621. The rotating section 621 is a substantially rectangular strip and defines a through hole 623 corresponding to the fixing holes 614. The rotating section 621 can be detachably received within the second receiving space 612, and a shaft 624 passes through the fixing holes 614 and the through hole 623 to connect the main body 61 and the pressing portion 62. Thus, the pressing portion 62 can rotate around the shaft 624 relative to the main body 61.

The pressing section 622 is a substantially rectangular strip and can be received within the first receiving space 611. The pressing section 622 defines an assembly hole 625 aligned with the groove 613. The assembly hole 625 can receive and hold a spring 626, and the other end of the spring 626 is fixed in the groove 613. Thus, when the pressing portion 62 is pressed into the first receiving space 611, the spring 626 is compressed and provides a restoring force to push the pressing portion 62 out of the first receiving space 611 and the second receiving space 612.

Each clamping portion 63 is substantially L-shaped, and includes a fixing section 631, a connecting section 632, and a clamp section 633. The fixing section 631 is a substantially rectangular plate. One of the fixing sections 631 is fixed on the second surface 602 for example by a threaded connection and the other fixing section 631 is fixed on the pressing section 622 by a threaded connection. The clamp section 633 and the fixing section 631 are perpendicularly located at the opposite ends and sides of the connecting section 632. The clamp section 633 is a substantially cylinder and is made from polyurethane, rubber or other elastic materials to clamp and hold the antenna 80.

The antenna assembly fixture 100 further includes a limiting portion 70 detachably located on the base body 10 between the first mounting structure 20 and the second mounting structure 40 to limit the displacement of the second mounting structure 40. When the second mounting structure 40 moves towards the first mounting structure 20, the second mounting structure 40 is limited by the limiting portion 70 at a predetermined position, to reserve a distance to assemble the antenna 80.

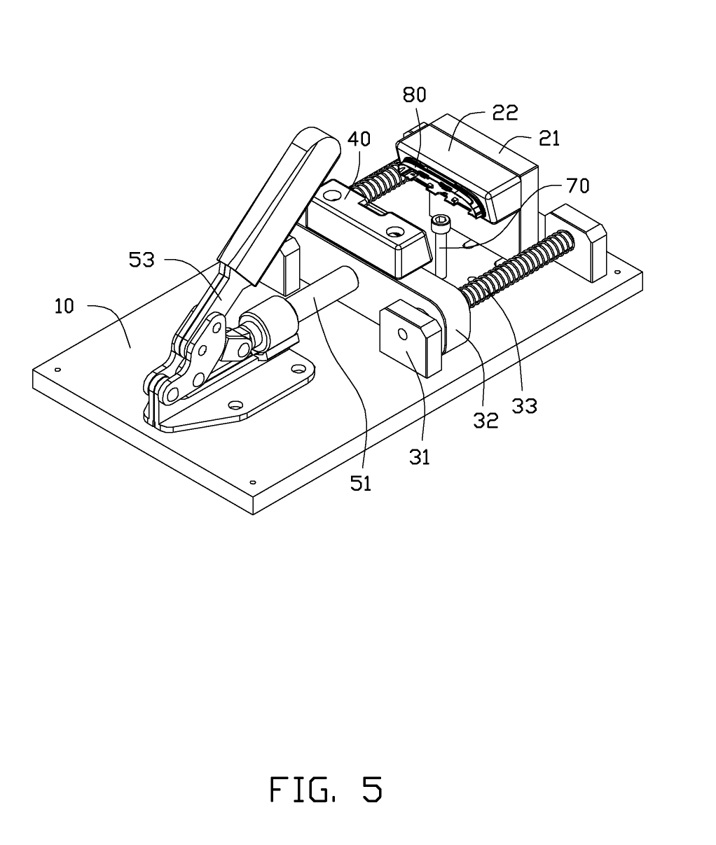

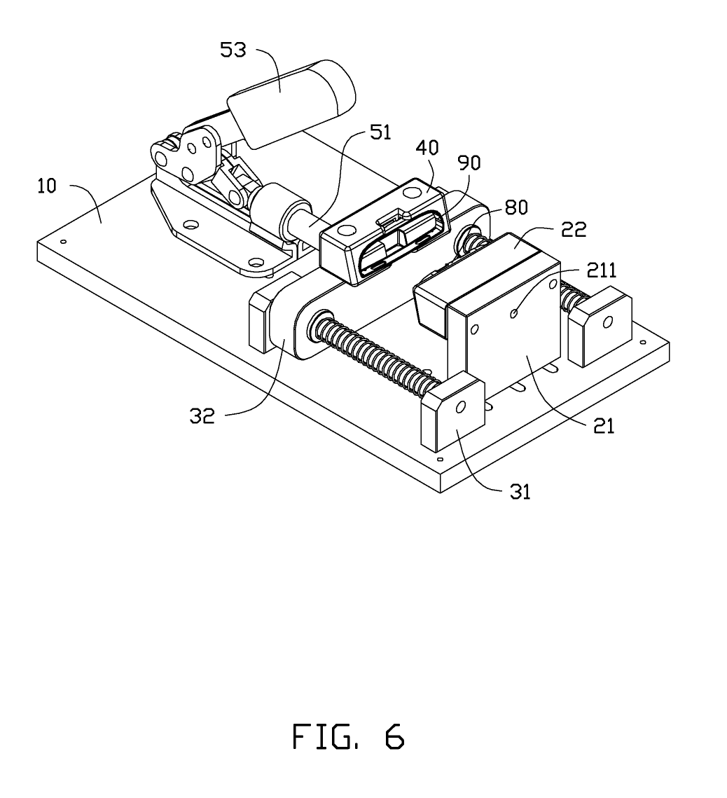

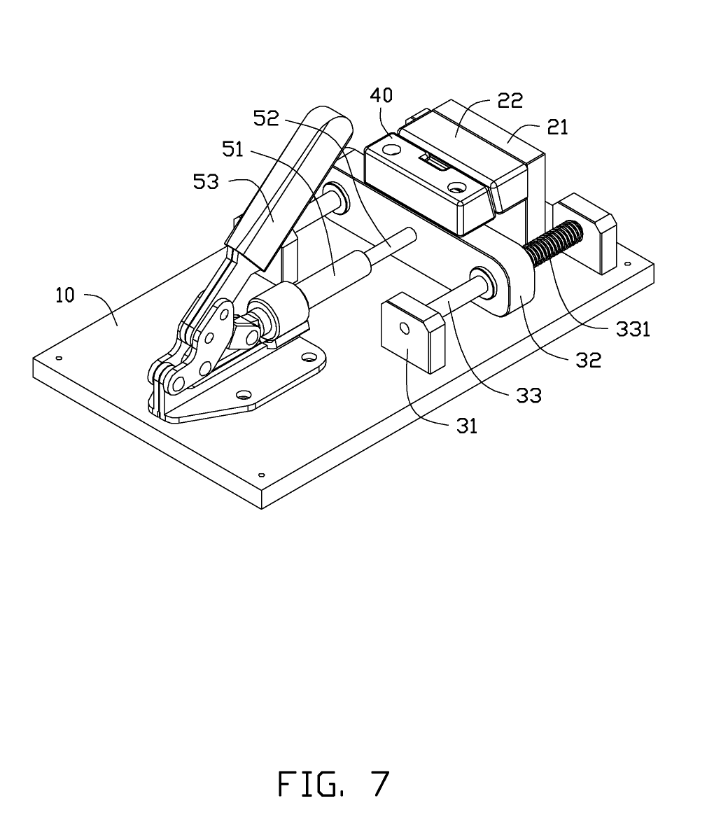

Referring to FIGS. 4 and 5, in use, the pressing section 622 is pressed towards the first receiving space 611, the spring 626 deforms, and the two clamping portions 63 are inserted into the antenna 80. By releasing the pressing section 622, the clamping portions 63 resist against inner wall of the antenna 80 by the restoring force of the spring 626 to clamp and hold the antenna 80. The clamping structure 60 moves the antenna 80 into the first mounting slot 221, and the vacuum source V is activated, the suction holes 222 holds the antenna 80 with suction to prevent the antenna 80 from falling off the first mounting portion 22. The clamping structure 60 is removed. Referring to FIGS. 6 and 7, the securing frame 90 is positioned in the second mounting slot 41. By operating the drive handle 53, the sliding portion 32 slides along the guiding posts 33, and the second mounting structure 40 moves towards the first mounting structure 20 until the second mounting structure 40 is limited by the limiting portion 70. Thus, the securing frame 90 touches the antenna 80, and the antenna 80 is joined securely into the securing frame 90 by adhesion. By operating the drive handle 63, the second mounting structure 40 moves away from the first mounting structure 20, the antenna 80 with the securing frame 90 and is removed from the first mounting slot 221.

In the antenna assembly fixture 100 of the present disclosure, the clamping structure 60 can hold and move the antenna 80 into the first mounting slot 221 of the first mounting structure 20, and the securing frame 90 can be positioned in the second mounting slot 41. The drive handle 53 drives the second mounting structure 40 to move towards the first mounting structure 20. Thus, the antenna 80 can be securely and quickly joined into the securing frame 90, improving efficiency of the whole assembly, and eliminate gaps between the securing frame 90 and the antenna 80.

In the present specification and claims, the word “a” or “an” preceding an element does not exclude the presence of a plurality of such elements. Further, the word “comprising” does not exclude the presence of elements or steps other than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of this exemplary disclosure to the full extent indicated by the broad general meaning of the terms in which the appended claims are expressed.

What is claimed is:

1. An antenna assembly fixture for assembling a securing frame to an antenna, the antenna assembly fixture comprising:
a base body;
a first mounting structure located on the base body and defining a first mounting slot, and the first mounting slot for holding the antenna;
a sliding structure located on the base body, the sliding structure comprising:
two positioning plates located on the base body;
a guiding post detachably positioned at the two positioning plates; and
a sliding portion located between the two positioning plates; and a second mounting structure located on the sliding portion, wherein the second mounting structure defines a second mounting slot, the second mounting slot aligns with the first mounting slot and holds the securing frame, the sliding portion moves along the guiding post and enables the securing frame to move towards the antenna for assembling the securing frame to the antenna.

2. The antenna assembly fixture as claimed in claim 1, wherein the first mounting structure comprises a fixing plate and a mounting portion, the fixing plate is detachably located on the base body, the mounting portion is detachably assembled on the fixing plate, and the mounting slot is for accommodating the antenna.

3. The antenna assembly fixture as claimed in claim 2, wherein the fixing plate defines a plurality of air holes, the mounting portion further defines a plurality of suction holes in the first mounting slot and communicating with the corresponding air holes, and the plurality of air holes communicate with a vacuum source through air pipes, air is sucked out the air holes and the suction holes to hold the antenna with suction to prevent the antenna from falling off the first mounting portion.

4. The antenna assembly fixture as claimed in claim 1, wherein each positioning plate defines a positioning hole, the sliding portion defines two sliding holes at opposite ends of the sliding portion, and each sliding hole is aligned with the positioning holes of the two positioning plates, the guiding post can pass through the sliding hole and be removable in the sliding hole, the opposite ends of the guiding post are detachably fixed in the two positioning holes, and the sliding portion can move back-and-forth along the sliding posts.

5. The antenna assembly fixture as claimed in claim 4, further comprising a driving structure fixed onto the base body, wherein the driving structure comprises an drive cylinder and a connection post, the sliding portion defines a connection hole between the sliding holes, one end of the connection post is fixed in the connection hole of the sliding portion, and the other end of the connection post is removably received within the drive cylinder.

6. The antenna assembly fixture as claimed in claim 5, wherein the driving structure further comprises a drive handle, the drive handle is connected to the drive cylinder to push and pull the drive cylinder, and the connection post moves back-and-forth in the drive cylinder to enable the sliding portion to slide back-and-forth along the guiding post.

7. The antenna assembly fixture as claimed in claim 1, further comprising a clamping structure to clamp and move the antenna into the first mounting slot, wherein the clamping structure comprises a main body comprising a first surface and a second surface parallel to the first surface, the main body defines a first receiving space and a second receiving space, and the first receiving space is located at the first surface, the second receiving space is located at the first surface and communicates with the first receiving space.

8. The antenna assembly fixture as claimed in claim 7, wherein the clamping structure further comprises a pressing portion, the pressing portion comprises a rotating section, the second receiving space defines two fixing holes at the opposite sidewalls, the rotating section defines a through hole corresponding to the fixing holes, the rotating section is detachably received within the second receiving space, and a shaft can pass through the fixing holes and the through hole to connect the main body and the pressing portion, the pressing portion can rotate around the shaft relative to the main body.

9. The antenna assembly fixture as claimed in claim 8, wherein the pressing portion further comprises a pressing section connected to the rotating section, the main body further defines a groove, the pressing section is received within the first receiving space and defines an assembly hole aligned with the groove, and a spring is received in the assembly hole, the other end of the spring is fixed in the groove, and when the pressing portion is pressed into the first receiving space, the spring is compressed and provides a restoring force to push the pressing portion out from the first receiving space.

10. The antenna assembly fixture as claimed in claim 9, wherein the clamping structure further comprises two clamping portions, each clamping portion comprises a fixing section, a connecting section and a clamp section, one of the fixing sections is fixed on the second surface, the other fixing section is fixed on the pressing section, the clamp section and the fixing section are located at the opposite ends and sides of the connecting section, and the clamp section is made from polyurethane, rubber or other elastic materials to clamp and hold the antenna.

11. The antenna assembly fixture as claimed in claim 1, further comprising a limit portion detachably located on the base body and between the first mounting structure and the second mounting structure to limit the displacement of the second mounting structure, wherein when the second mounting structure moves towards the first mounting structure, the second mounting structure is limited by the limit portion at a predetermined position to reserve a distance to assemble the antenna.

12. An antenna assembly fixture for assembling a securing frame to an antenna, the antenna assembly fixture comprising:
a base body;
a first mounting structure located on the base body to secure the antenna;
a sliding structure located on the base body, the sliding structure comprising:
two positioning plates located on the base body;
a guiding post detachably positioned at the two positioning plates; and
a sliding portion located between the two positioning plates and moving along the guiding post;
a second mounting structure located on the sliding portion to secure the securing frame; and
a driving structure fixed on the base body, wherein the driving structure is connected to the sliding portion, when the driving structure is operated, the sliding portion slides along the guiding posts, the second mounting structure moves towards the first mounting structure until the securing frame contacts the antenna, and the antenna is joined and assembled to the securing frame.

13. The antenna assembly fixture as claimed in claim 12, wherein the first mounting structure comprises a fixing plate and a mounting portion, the fixing plate is detachably located on the base body, the mounting portion is detachably assembled on one side of the fixing plate, and the size and shape of the mounting slot are substantially the same as those of the antenna to accommodate the antenna.

14. The antenna assembly fixture as claimed in claim 13, wherein the fixing plate defines a plurality of air holes, the mounting portion further defines a plurality of suction holes in the first mounting slot and communicating with the corresponding air holes, and the plurality of air holes communicate with a vacuum source through air pipes, air is sucked out the air holes and the suction holes to hole the antenna with suction to prevent the antenna from falling off the first mounting portion.

15. The antenna assembly fixture as claimed in claim 12, wherein each positioning plate defines a positioning hole, the sliding portion defines two sliding holes at opposite ends of the sliding portion, and each sliding hole is aligned with the positioning holes of the positioning plates, the guiding post can pass through the sliding hole and be removable in the sliding hole, the opposite ends of the guiding post are detachably fixed in the two positioning holes, and the sliding portion can move back-and-forth along the sliding posts.

16. The antenna assembly fixture as claimed in claim 14, wherein the driving structure comprises a drive cylinder, a connection post and a drive handle, the sliding portion defines a connection hole between the sliding holes, one end of the connection post is fixed in the connection hole of the sliding portion, and the other end of the connection post is removably received within the drive cylinder, the drive handle is connected to the drive cylinder to push and pull the drive cylinder, the connection post moves back-and-forth in the drive cylinder to enable the sliding portion to slide back-and-forth along the guiding posts.

17. The antenna assembly fixture as claimed in claim 12, further comprising a clamping structure to clamp and move the antenna into the first mounting slot, wherein the clamping structure comprises a main body comprising a first surface and a second surface parallel to the first surface, the main body defines a first receiving space and a second receiving space, and the first receiving space is located at the first surface, the second receiving space is located at the first surface and communicates with the first receiving space.

18. The antenna assembly fixture as claimed in claim 17, wherein the clamping structure further comprises a pressing portion, the pressing portion comprises a rotating section, the second receiving space defines two fixing holes at the opposite sidewalls, the rotating section defines a through hole corresponding to the fixing holes, the rotating section is detachably received within the second receiving space, and a shaft can pass through the fixing holes and the through hole to connect the main body and the pressing portion, the pressing portion can rotate around the shaft relative to the main body.

19. The antenna assembly fixture as claimed in claim 18, wherein the pressing portion further comprises a pressing section connected to the rotating section, the main body further defines a groove, the pressing section is received within the first receiving space and defines an assembly hole aligned with the groove, and a spring is located between the assemble hole and the groove, when the pressing portion is pressed into the first receiving space, the spring is compressed and provides a restoring force to push the pressing portion out from the first receiving space.

20. The antenna assembly fixture as claimed in claim 19, wherein the clamping structure further comprises two clamping portions, each clamping portion comprises a fixing section, a connecting section and a clamp section, one of the fixing sections is fixed on the second surface, the other fixing section is fixed on the pressing section, the clamp section and the fixing section are located at the opposite ends and sides of the connecting section, and the clamp section is made from polyurethane, rubber or other elastic materials to clamp and hold the antenna.
